(19) United States
(12) Patent Application Publication
(10) Pub. No.: US 2005/0259156 A1
(43) Pub. Date: Nov. 24, 2005

(54) Camera-shake compensation apparatus and position detection apparatus

(75) Inventors: Akira Kosaka, Osaka (JP); Satoshi Masuda, Kyoto-shi (JP); Yoshihiro Hara, Osaka (JP); Fumiaki Ishito, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 10/988,744

(22) Filed: Nov. 15, 2004

(30) Foreign Application Priority Data
May 18, 2004 (JP) JP2004-147315

(51) Int. Cl. H04N 5/228

(52) U.S. Cl. 348/208.7

(57) ABSTRACT

A base plate, a first slider and a second slider are fit in one another to produce one assemblage. The first slider is caused to move relative to the base plate along an X axis by a first actuator. The second slider moves in unison with the first slider, and also is caused to solely move along a Y axis by a second actuator. A magnetic sensor unit is provided in the base plate, and a magnet support is provided in the second slider so as to face the magnetic sensor unit. A magnet is disposed on a lower face of the magnet support. The magnetic sensor unit and the magnet form a position detection mechanism, and the second slider in which the magnet is disposed requires no electric wiring.

This application is based on application No. 2004-147315 filed in Japan, the contents of which are hereby incorporated by reference.

### BACKGROUND OF THE INVENTION

1. Field of the Invention

The present invention relates to a camera-shake compensation apparatus of an image capture apparatus and a position detection apparatus applicable to the camera-shake compensation apparatus.

2. Description of the Background Art

As an image capture apparatus such as a digital camera, well known is of a type which cancels image blur on a receiving face by causing an imaging device to move responsive to possible camera shake which is likely to occur during photographing (as taught in Japanese Patent Application Laid-Open No. 2003-110929, for example, which will be hereinafter referred to as “JP 2003-110929”).

In a camera-shake compensation apparatus taught in JP 2003-110929, assuming that the apparatus is roughly divided into a moving side at which a moving part holding and moving an imaging device is situated and a fixed side at which a fixed part is situated, a light emitting device such as an infrared LED is disposed at the moving side and a light receiving device such as PSD (position sensitive device) capable of identifying a position where light is to be received is disposed in the fixed side so as to face the light emitting device. With this arrangement, a position of the imaging device is detected in order to control movement of the imaging device.

Information about the position of the imaging device which is detected by the above-described position detection mechanism is used when a drive part configured as an impact actuator moves the moving part frictionally engaged with the fixed part.

However, the conventional camera-shake compensation apparatus described above requires installation of electric wiring in each of the light emitting device and the light receiving device. As such, the conventional camera-shake compensation apparatus suffers from the need of installation of wiring for position detection in both the fixed part and the moving part during assembling the camera-shake compensation apparatus. Also, to use the infrared LED, the PSD or the other component, which is relatively expensive, would result in increased cost for components.

### SUMMARY OF THE INVENTION

It is therefore an object of the present invention to provide a camera-shake compensation apparatus and a position detection apparatus which eliminate the need of installation of electric wiring in at least one of a fixed part and a moving part to thereby improve efficiency in wiring, as well as maintain low cost.

The present invention is directed to a position detection apparatus.

A position detection apparatus according to the present invention includes: a fixed part; a moving part movable relative to the fixed part along two differential axes in a predetermined plane through a first guide part and a second guide part; and a detector for detecting a position of the moving part relative to the fixed part in the predetermined plane. The detector includes a plurality of magnetic-sensor groups which are arranged at one part of the fixed part and the moving part so as to extend along different axes in the predetermined plane, and a magnet which is arranged at the other part so as to face the plurality of magnetic-sensor groups, each of the plurality of magnetic-sensor groups including two magnetic sensors.

The foregoing structure allows satisfactory detection of the position of the moving part in the predetermined plane. Also, there is no need of installing electric wiring in a part in which the magnet is provided. Further, the magnet is less expensive than a semiconductor component or the like, the position detection apparatus can be implemented at a lower cost.

According to a preferred embodiment of the present invention, the plurality of magnetic-sensor groups are provided in the fixed part, and the magnet is provided in the moving part.

There is no need of installing electric wiring in the moving part. Accordingly, a resistance to movement of the moving part can be reduced.

According to another preferred embodiment of the present invention, in the detection apparatus, the plurality of magnetic-sensor groups are two magnetic-sensor groups which intersect each other at right angles to form a cross-shaped array, and the magnet is a single magnet which faces an approximate center of the cross-shaped array formed by the two magnetic-sensor groups, preferably.

It is possible to detect positions on two axes perpendicular to each other by using a single magnet, to thereby allow for minimization of the size of the position detection apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a structure of an image capture apparatus with a camera-shake compensation function.

FIG. 2 is an exploded perspective view of a camera-shake compensation apparatus which also functions as a position detection apparatus.

FIG. 3 is a magnified view of principal parts of a magnet support when viewed from the front.

FIG. 4 illustrates a structure of a first or second actuator.

FIG. 5 is a sectional view taken along a line I-I in FIG. 2.

FIG. 6 is a block diagram illustrating a circuit configuration of a magnetic sensor unit.

FIG. 7 is a block diagram showing electrical connection in a drive control circuit of the camera-shake compensation apparatus.

FIG. 8 illustrates a waveform of drive pulses applied in driving the actuator.

FIGS. 9A, 9B and 9C show respective operating conditions of the actuator.

### DESCRIPTION OF THE PREFERRED EMBODIMENTS

Below, a preferred embodiment of the present invention will be described in detail with reference to accompanying drawings. In the drawings, an X, Y, Z-three-dimensional Cartesian coordinate system is used in common.

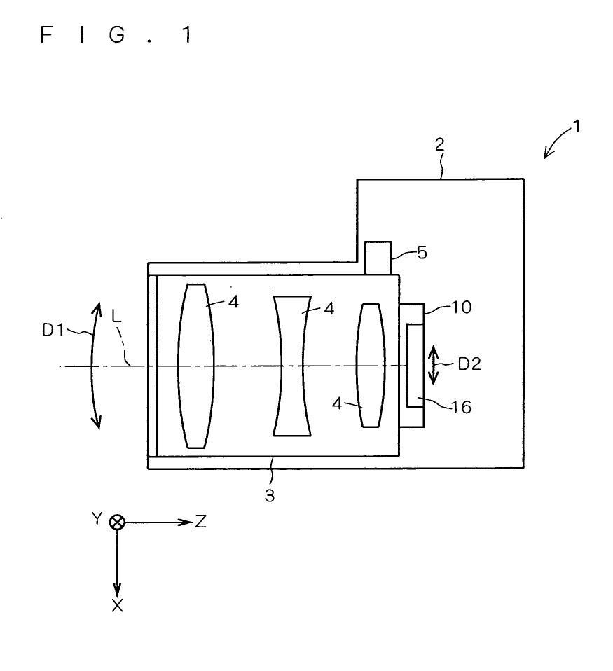

FIG. 1 illustrates an image capture apparatus 1 such as a digital camera which is capable of compensating for camera shake. The image capture apparatus 1 includes a camera body 2, a lens barrel 3 in which a plurality of lenses 4 are mounted, a camera-shake compensation apparatus 10 attached to an end face of the lens barrel 3, and a gyro sensor 5 secured to a side face of the lens barrel 3.

In the camera-shake compensation apparatus 10, an imaging device 16 such as a CCD is provided. The camera-shake compensation apparatus 10 moves the imaging device 16 in an X-Y plane perpendicular to an optical axis L in response to shake of the image capture apparatus 1 which is detected by the gyro sensor 5, to compensate for camera shake. For example, consider a situation where the image capture apparatus 1 shakes as indicated by a two-headed arrow D1 in FIG. 1 in photographing using the image capture apparatus 1, so that the optical axis L of light incident upon the lens barrel 3 deviates. In such situation, the camera-shake compensation apparatus 10 moves the imaging device 16 as indicated by a two-headed arrow D2 in FIG. 1, to thereby compensate for the deviation of the optical axis L. The camera-shake compensation apparatus 10 incorporates a position detection function of a position detection apparatus according to the present invention, and is configured to detect a current position of the imaging device 16 in the X-Y plane by performing the position detection function in compensating for camera shake, and to use information about the current position of the imaging device 16 as feedback information for controlling the position of the imaging device 16 with high accuracy.

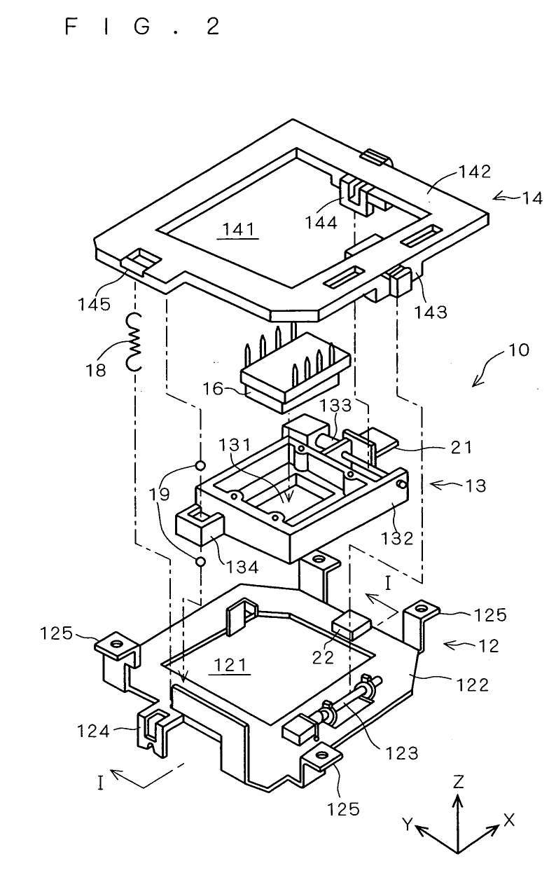

FIG. 2 is an exploded perspective view of the camera-shake compensation apparatus 10 which also functions as the position detection apparatus. As illustrated in FIG. 2, the camera-shake compensation apparatus 10 includes an assemblage formed of three parts of: a base plate 12 secured to the end face of the lens barrel 3; a first slider 14 which is movable relative to the base plate 12 along an X axis; and a second slider 13 which is movable relative to the first slider 14 along a Y axis, as principal parts.

The base plate 12 includes a metal frame 122 which is annular by inclusion of an opening 121 at a center thereof, as a base material. The metal frame 122 is secured to the lens barrel 3. The base plate 12 includes a first actuator 123 extending along the X axis and a magnetic sensor unit 22 including a plurality of Hall effect devices (magnetic sensors). The first actuator 123 and the magnetic sensor unit 22 are provided on the metal frame 122. Further, a first spring hanger 124 is provided in a predetermined position in an outer edge of the metal frame 122, and L-shaped substrate supports 125 are provided in respective positions in the outer edge of the metal frame 122.

The second slider 13 includes a frame 132 which is made of resin and includes an opening 131 at a center thereof. The imaging device 16 can be fit in the opening 131 of the frame 132 and secured to the frame 132. The second slider 13 further includes a second actuator 133 extending along the Y axis, a hard sphere pocket 134 in which hard spheres 19 are fit with clearance while being located on opposite faces of the pocket 134 along a Z axis, and a magnet support 21 for supporting a magnet. The second actuator 133, the hard sphere pocket 134 and the magnet support 21 are provided on the frame 132. The magnet support 21 is situated outwardly from the second actuator 133 relative to the opening 131, so as to face the magnetic sensor unit 22 provided in the base plate 12.

FIG. 3 is a magnified view of the magnet support 21 which illustrates principal parts of the magnet support 21 when viewed from the front. As illustrated in FIG. 3, the magnet support 21 includes a plate-shaped magnet supporting arm 212 which extends outwardly from a wall 211 situated outwardly from the second actuator 133. The magnet supporting arm 212 includes a magnet receiver 213 at a lower face of an edge portion thereof. The magnet receiver 213 is configured such that a magnet 23 can be fit in and secured to the magnet receiver 213. The magnet 23 secured to the lower face of the magnet supporting arm 212 is situated so as to face the magnetic sensor unit 22 in the base plate 12 as illustrated in FIG. 3. Also, the magnet 23 and the magnetic sensor unit 22 are disposed such that a lower face of the magnet 23 and an upper face of the magnetic sensor unit 22 are substantially parallel to each other.

Referring back to FIG. 2, the first slider 14 includes an annular frame 142 which is made of aluminum and includes an opening 141 at a center thereof, as a base material. The second slider 13 is fit in the opening 141 of the annular frame 142. The first slider 14 further includes a first friction-engagement part 143, a second friction-engagement part 144, and a second spring hanger 145 which are provided in the annular frame 142. The first friction-engagement part 143 is situated so as to face the first actuator 123 of the base plate 12, and the second friction-engagement part 144 is situated so as to face the second actuator 133 of the second slider 13. Further, the second spring hanger 145 is situated so as to face the first spring hanger 124 of the base plate 12.

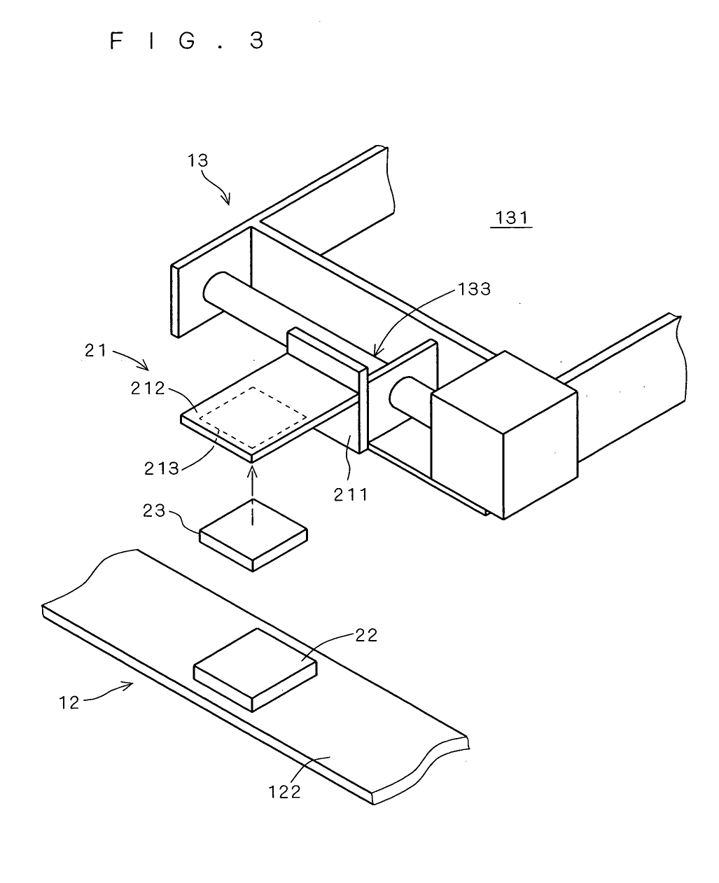

Each of the first actuator 123 and the second actuator 133 includes a static part 31, a piezoelectric element 32 and a drive rod 33 as illustrated in FIG. 4. The static part 31 is secured to the base plate 12 or the second slider 13. The piezoelectric element 32 includes one end secured to the static part 31 and the other end connected to the drive rod 33. Those components of each of the first and second actuators 123 and 133 are configured such that the drive rod 33 moves a given distance in a given direction in accordance with drive pulses applied to the piezoelectric element 32. In this regard, the drive rod 33 moves along a length of each of the first and second actuators 123 and 133, that is, in directions indicated by a two-headed arrow 34 in an example illustrated in FIG. 4.

When the above-described camera-shake compensation apparatus 10 is assembled, the imaging device 16 is fit in the opening 131 of the second slider 13 to be secured to the second slider 13. Also, the drive rod 33 of the first actuator 123 is frictionally engaged with the first friction-engagement part 143, and the drive rod 33 of the second actuator 133 is frictionally engaged with the second friction-engagement part 144. Further, a spring 18 is stretched between the first spring hanger 124 and the second spring hanger 145, so that the base plate 12 and the first slider 14 are urged in respective directions which bring the base plate 12 and the first slider 14 close to each other. At that time, the second slider 13 is sandwiched between the base plate 12 and the first slider 14 with the hard spheres 19 interposed. Consequently, the base plate 12, the second slider 13 and the first slider 14 are arranged in a direction in which the Z axis extends (which is indicated by an arrow in FIG. 2 and will be hereinafter referred to as a “positive Z-axis direction”) in the order of occurrence in this sentence, with the second slider 13 being overlaid on the base plate 12 and the first slider 14 being overlaid on the second slider 13.

In the camera-shake compensation apparatus 10 as assembled in the foregoing manner, movement of the drive rod 33 of the first actuator 123 is followed by movement of the first friction-engagement part 143 frictionally engaged with the drive rod 33 of the first actuator 123, which involves movement of the first slider 14 relative to the base plate 12 along the X axis. Further, also the second slider 13 moves relative to the base plate 12 along the X axis in unison with the first slider 14. On the other hand, movement of the drive rod 33 of the second actuator 133 is followed by movement of the second friction-engagement part 144 frictionally engaged with the drive rod 33 of the second actuator 133, which involves movement of the second slider 13 relative to the first slider 14 along the Y axis. At that time, the first slider 14 does not move relative to the base plate 12, and thus the second slider 13 alone moves relative to the base plate 12 along the Y-axis.

As is made clear from the above description, each of the first slider 14 and the second slider 13 serves as a moving part which is capable of moving relative to the base plate 12 serving as a fixed part, while holding the imaging device 16, in the camera-shake compensation apparatus 10. The first slider 14 simply moves relative to the base plate 12 linearly along the X axis. In contrast thereto, the second slider 13 not only moves along the X axis in unison with the first slider 14, but also is capable of independently moving along the Y axis. The second slider 13 is configured to be capable of moving in the X-Y plane perpendicular to the optical axis while holding the imaging device 16.

It is noted that the respective drive rods 33 of the first actuator 123 and the second actuator 133 also function as guide parts for guiding the second slider 13 linearly along the X axis and the Y axis, respectively. The drive rod 33 of the first actuator 123 functions as a first guide part and the drive rod 33 of the second actuator 133 functions as a second guide part.

FIG. 5 is a sectional view taken along a line I-I in FIG. 2. FIG. 5 illustrates a state in which the camera-shake compensation apparatus 10 is assembled and attached to the lens barrel 3. In the camera-shake compensation apparatus 10, the magnetic sensor unit 22 provided in the base plate 12 and the magnet 23 attached to the second slider 13 are held to face each other in close proximity to each other. The magnetic sensor unit 22 is situated so as to be capable of satisfactorily detecting change in a magnetic field generated by the magnet 23. The second slider 13 is capable of moving in the X-Y plane as described above, and a position of the magnet 23 relative to the magnetic sensor unit 22 varies as the second slider 13 moves. Movement of the magnet 23 relative to the magnetic sensor unit 22 in the X-Y plane results in change of a magnetic field detected by the magnetic sensor unit 22. Hence, the magnetic sensor unit 22 detects a magnetic field which changes as the second slider 13 moves. Accordingly, it is possible to detect where the second slider 13 has moved or is moving (i.e., a current position of the second slider 12) via detection of change in a magnetic field generated by the magnet 23 which is performed by the magnetic sensor unit 22. Thus, the magnetic sensor unit 22 and the magnet 23 form a position detection mechanism 20 for detecting a position of the second slider 13 relative to the base plate 12. Since the magnet 23 does not require electric wiring, the position detection mechanism 20 employing the magnet 23 would produce advantages of significantly saving labors associated with installation of wiring.

The position detection mechanism 20 is situated in the X-Y plane at a level substantially identical to a level at which the imaging device 16 and the second actuator 133 are situated, and is opposite to the imaging device 16 with the second actuator 133 being interposed therebetween, in the camera-shake compensation apparatus 10 as assembled. Because of the position of the position detection mechanism 20 which is situated opposite to the imaging device 16 with the second actuator 133 being interposed therebetween, the second actuator 133 is inevitably interposed between the imaging device 16 and the magnet 23, so that the imaging device 16 and the magnet 23 can be distant from each other.

As generally known, to provide the magnet 23 and the imaging device 16 in close proximity to each other would likely cause degradation of image quality due to influences of a magnetic field generated by the magnet 23 upon an output signal (image signal) of the imaging device 16. In this regard, the camera-shake compensation apparatus 10 according to the preferred embodiment of the present invention in which the position detection mechanism 20 is situated opposite to the imaging device 16 with the second actuator 133 interposed therebetween, allows the imaging device 16 and the magnet 23 to be spaced a predetermined distance or more from each other, as described above. Hence, it is possible to suppress influences of a magnetic field generated by the magnet 23 upon an output signal of the imaging device 16 in the camera-shake compensation apparatus 10. Thus, even if local change in a magnetic field occurs as a result of movement of the magnet 23 following the movement of the second slider 13, it is possible to prevent degradation of the image quality with no substantial influence of the local change in the magnetic field being exercised upon an output signal (image signal) of the imaging device 16.

Also, even in a case where a magnetic material is used for forming a portion (lead frame, for example) of the imaging device 16, since the imaging device 16 and the magnet 23 are distant from each other, the imaging device 16 and the magnet 23 are in positional relationship which prevents the magnetic material from exercising substantial influence upon a magnetic field generated by the magnet 23, to thereby avoid reduction of accuracy in position detection performed by the position detection mechanism 20.

Further, the position detection mechanism 20, the imaging device 16 and the second actuator 133 are situated in the X-Y plane perpendicular to the optical axis at the substantially same level. As such, the position detection mechanism 20 does not increase a thickness of the camera-shake compensation apparatus 10 along the optical axis (along the Z axis). As a result, increase of a thickness along the optical axis of the image capture apparatus 1 can be suppressed, to thereby minimize the size of the image capture apparatus 1.

Moreover, because of the above-described arrangement in which the second actuator 133 is interposed between the imaging device 16 and the position detection mechanism 20, a moment which is caused by a weight of the magnet 23 and applied to the second actuator 133 and a moment which is caused by a weight of the imaging device 16 and applied to the second actuator 133 counterbalance each other in driving the second actuator 133, so that a twisting force applied to the drive rod 33 of the second actuator 133 is reduced. Accordingly, the drive rod 33 of the second actuator 133 and the second friction-engagement part 144 are in contact with each other more stably. Also, such balance between those moments suppresses unrequired vibration of the second slider 13 which is likely to occur in driving the second actuator 133, so that both the second slider 13 and the magnet 23 can move steadily. As a result, a reliable feedback control system can be implemented in the camera-shake compensation apparatus 10.

Furthermore, the camera-shake compensation apparatus 10 is configured to ensure that the second slider 13 is kept substantially parallel to the base plate 12 in moving in the X-Y plane as illustrated in FIG. 5, in order to meet the requirement that an image capture function performed by the imaging device 16 be kept effective even when camera shake occurs. Accordingly, when the second slider 13 moves relative to the base plate 12, a vertical distance d between the magnet 23 and the magnetic sensor unit 22 (a distance along the Z axis) in the position detection mechanism 20 is kept substantially constant. As is generally known, change of the (vertical) distance d between the magnet and the magnetic sensor unit, if caused, would adversely affect an accuracy in position detection in the X-Y plane. According to the preferred embodiment of the present invention, however, the distance d in the position detection mechanism 20 is kept substantially constant as described above, so that reduction of the accuracy in position detection can be prevented. Thus, the position detection mechanism 20 is implemented as a position detection apparatus suitable for the camera-shake compensation apparatus 10.

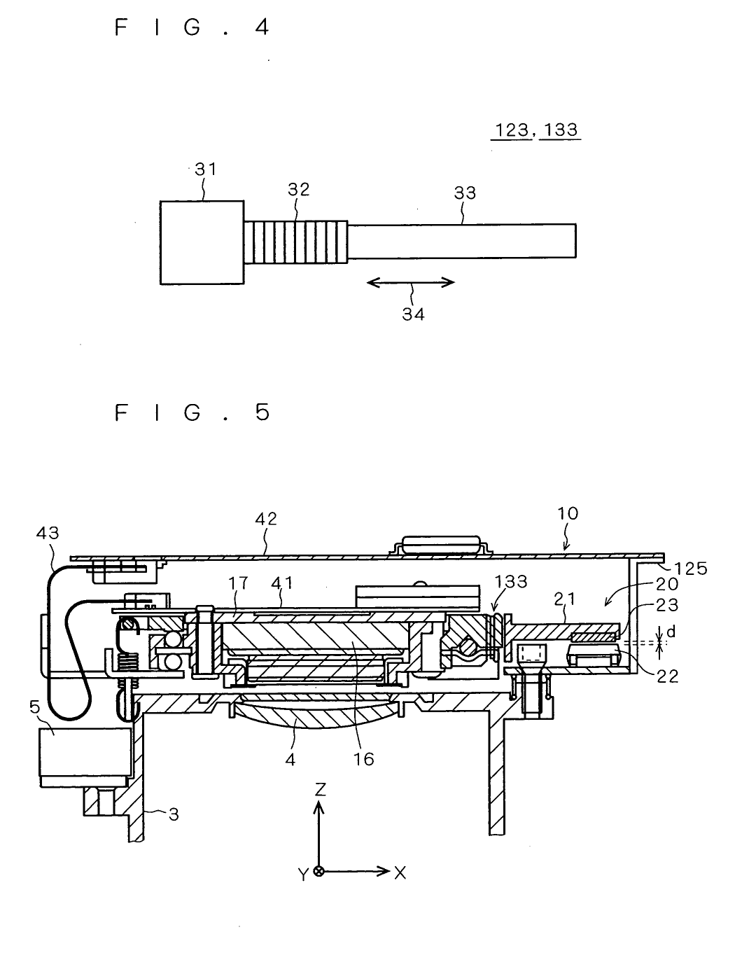

FIG. 6 is a block diagram illustrating a circuit configuration of the magnetic sensor unit 22. The magnetic sensor unit 22 includes a sensor package 22a situated to face the magnet 23 and four Hall effect devices 221, 222, 223 and 224 contained in the sensor package 22a. Out of the four Hall effect devices, two Hall effect devices 221 and 222 are provided to detect a magnetic field along the X axis, and form a magnetic sensor array extending along the X axis. On the other hand, the other two Hall effect devices 223 and 224 are provided to detect a magnetic field along the Y axis, and form a magnetic sensor array extending along the Y axis. The magnetic sensor array which is formed of the Hall effect devices 221 and 222 and extends along the X axis and the magnetic sensor array which is formed of the Hall effect devices 223 and 224 and extends along the Y axis intersect with each other at right angles, to form a cross-shaped array with respective centers overlapping each other.

As a result of the arrangement of the four Hall effect devices as illustrated in FIG. 6, detection of change in both magnetic fields along the X axis and the Y axis can be achieved by simply providing the sensor package 22a alone in the magnetic sensor unit 22. Then, by simply providing the magnet 23 alone which faces the sensor package 22a (more precisely, a center of the cross-shaped array formed by the magnetic sensor arrays), the position detection mechanism 20 capable of detecting positions on the X axis and the Y axis can be implemented. Hence, the arrangement of the Hall effect devices, 221, 222, 223 and 224 as illustrated in FIG. 6 is convenient for minimization of the size of the position detection mechanism 20.

In operation, an output signal (analog signal) is supplied from each of the Hall effect devices 221 and 222 to a differential amplifier 225, which then generates an amplified differential signal and supplies the amplified differential signal to a detection circuit 227. Likewise, an output signal is supplied from each of the Hall effect devices 223 and 224 to a differential amplifier 226, which then generates an amplified differential signal and supplies the amplified differential signal to the detection circuit 227. The detection circuit 227 converts the signals received from the differential amplifiers 225 and 226 into values representing a current position of the magnet 23 in the X-Y plane, that is, values of coordinates X and Y. By referring to those coordinate values, respective current positions of the second slider 13 and the imaging device 16 can be uniquely obtained. The coordinate values outputted from the detection circuit 227 are supplied to an output circuit 228, which then outputs the received coordinate values to a microcomputer which will be later described in detail. It is additionally noted that the differential amplifiers 225 and 226, the detection circuit 227 and the output circuit 228 may be either contained in the sensor package 22a or provided in a second substrate 42 (which will be later described), apart from the sensor package 22a situated to face the magnet 23.

In the arrangement illustrated in FIG. 6, the magnetic sensor array formed of the Hall effect devices 221 and 222 is situated to extend substantially in the direction of movement of the first actuator 123 (i.e., along the X axis), and the magnetic sensor array formed of the Hall effect devices 223 and 224 is situated to extend substantially in the direction of movement of the second actuator 133 (i.e., along the Y axis). Accordingly, a coordinate system used for identifying the coordinate values detected by the magnetic sensor unit 22 is substantially identical to a coordinate system used for controlling the first and second actuators 123 and 133. This eliminates the need of performing coordinate transformation in signal processing, to thereby carry out signal processing effectively.

Additionally, provision of two Hall effect devices for detecting a magnetic field along each axis is intended to suppress reduction of accuracy in position detection even with change in ambient temperature or the like. More specifically, while feedback control is exerted such that a value resulted from addition of output signals of the two Hall effect devices is kept constant, a value resulted from subtraction of the output signals of the two Hall effect devices is employed as the output signal which is to be supplied to the differential amplifier. In this manner, influences of change in ambient temperature or the like can be removed.

In the meantime, slight shift of components along the X axis or the Y axis which is likely to occur due to errors contained in the components or errors caused during assembling can be recognized by monitoring an output signal which is supplied from the magnetic sensor unit 22 while causing the second slider 13 to actually move in the X-Y plane, after assembling the camera-shake compensation apparatus 10. An amount of the recognized shift is previously stored in a memory or the like. Then, the output signal supplied from the magnetic sensor unit 22 is corrected based on the stored shift amount, to thereby relatively easily eliminate errors caused during assembling or other errors.

Referring back to FIG. 5, a first substrate 41 is provided on a back face (one of opposite faces which is situated in the positive Z-axis direction relative to the other face) of the imaging device 16 fit in the second slider 13, with a heat dissipation plate 17 being interposed therebetween. The imaging device 16 is connected to the first substrate 41. Accordingly, the first substrate 41 moves along the X axis and the Y axis in unison with the second slider 13. Also, the second substrate 42 is secured to the substrate supports 125 of the base plate 12. The first substrate 41 and the second substrate 42 are arranged along the optical axis (along the Z axis) while being overlaid upon each other. The first substrate 41 moves in parallel to the second substrate 42 as the second slider 13 moves. The first substrate 41 and the second substrate 42 are connected to each other by a flexible substrate 43, and configured to allow transmission and reception of a signal therebetween.

The magnetic sensor unit 22 is connected to the second substrate 42 by a signal line not illustrated. Also the gyro sensor 5 which detects shake of the image capture apparatus 1 and outputs a signal indicative of an angular rate (angular rate signal) of shake along the X axis and the Y axis is connected to the second substrate 42 by a signal line not illustrated.

The first substrate 41 is provided with an element or a circuit for controlling the imaging device 16. An output signal (image signal) of the imaging device 16 is supplied to the second substrate 42 via the flexible substrate 43. The second substrate 42 is provided with a circuit for processing the output signal of the imaging device 16 or a circuit for processing a signal supplied from the magnetic sensor unit 22 which detects a position of the second slider 13. The second substrate 42 is further provided with a control circuit (a circuit including a microcomputer or the like) for controlling drive of the first and second actuators 123 and 133 based on a signal indicative of a position (values of coordinate X and Y) which is received from the output circuit 228 and the angular rate signal received from the gyro sensor 5. Then, the second substrate 42 outputs the image signal captured in the imaging device 16 to a control circuit which is provided within the image capture apparatus 1 but not included in the camera-shake compensation apparatus 10, and sends a drive signal (drive pulses) to each of the first and second actuators 123 and 133 connected to the second substrate 42 by a signal line not illustrated.

In arranging circuits in the foregoing manner, the magnet 23 provided in the second slider 13 does not require electric wiring, so that a wiring pattern for each of the first substrate 41 and the second substrate 42 can be made relatively easy. This increases flexibility in arrangement of components or wires during a designing process, and improves efficiency in assembling. In particular, since installation of wiring in a moving part results in creation of a resistance to movement of the moving part in some cases, it is desired to avoid installation of wiring in the moving part if possible. According to the preferred embodiment of the present invention, desirable arrangement is achieved, in which the magnet 23 is provided in the second slider 13 serving as a moving part so that the movement of the second slider 13 is not obstructed by wiring in the position detection mechanism 20.

As described above, the camera-shake compensation apparatus 10 is assembled with the base plate 12, the first slider 14 and the second slider 13 being fit in one another. When the camera-shake compensation apparatus 10 is attached to the lens barrel 3, a mechanism for holding and shaking the imaging device 16 and a mechanism for performing position detection are situated in an unused space in an overall space defined by components required to implement an optical system including the lens barrel 3 and the imaging device 16. As such, an optical unit including those mechanisms can be sized to be relatively small.

Next, operations of the above-described camera-shake compensation apparatus 10 will be described. FIG. 7 is a block diagram illustrating electrical connection in a drive control circuit of the camera-shake compensation apparatus 10 according to the preferred embodiment of the present invention. The drive control circuit includes: the gyro sensor 5 for detecting deviation of the optical axis L of light incident upon the lens barrel 3 and outputting an angular rate signal, the magnetic sensor unit 22 for detecting a position of the second slider 13 (or the imaging device 16); a microcomputer 101 for exerting comprehensive control for compensation for camera shake and calculating an amount to drive the sliders 13 and 14 based on various signals inputted to the microcomputer 101; and a drive circuit 102 for generating drive pulses at a predetermined frequency based on a drive signal supplied from the microcomputer 101. The drive pulses generated by the drive circuit 102 are outputted to the first and second actuators 123 and 133, upon application of which the first and second sliders 14 and 13 moves along lengths of the first and second actuators.

The gyro sensor 5 detects an angular rate of movement along the two axes (along the X axis and the Y axis) and outputs a signal indicative of the detected angular rate (angular rate signal) to the microcomputer 101, in response to shake of the camera body 2 indicated by the arrow D1 in FIG. 7.

The microcomputer 101, upon receipt of the angular rate signal from the gyro sensor 5, calculates an amount and a speed of shift of an image on the imaging device 16 (in particular, on an image forming face) which occurs due to image blur, based on a signal indicative of a focal length of the optical system. Subsequently, the microcomputer 101 determines a supply voltage which should be applied to the first and second actuators 123 and 133 at a predetermined frequency, based on the calculated speed of shift and a current position of the second slider 13 (or the imaging device 16). To this end, the microcomputer 101 compares the current position where the second slider 13 (or the imaging device 16) is actually being situated, with an original position where the imaging device 16 is supposed to be situated under normal conditions. The current position of the second slider 13 (or the imaging device) is obtained based on a signal received from the magnetic sensor unit 22, and the original position is determined based on the angular rate signal received from the gyro sensor 5. Then, the microcomputer 101 exerts feedback control for driving the sliders 13 and 14 so that the imaging device 16 moves to the original position.

The drive circuit 102 receives the drive signal from the microcomputer 101, and outputs drive pulses at a frequency which is about seven-tenth a resonance frequency of the actuators 123 and 133. The drive pulses are applied to the piezoelectric element 32, to cause each of the first and second sliders 14 and 13 to move along the drive rod 33 in accordance with the following principle of operation.

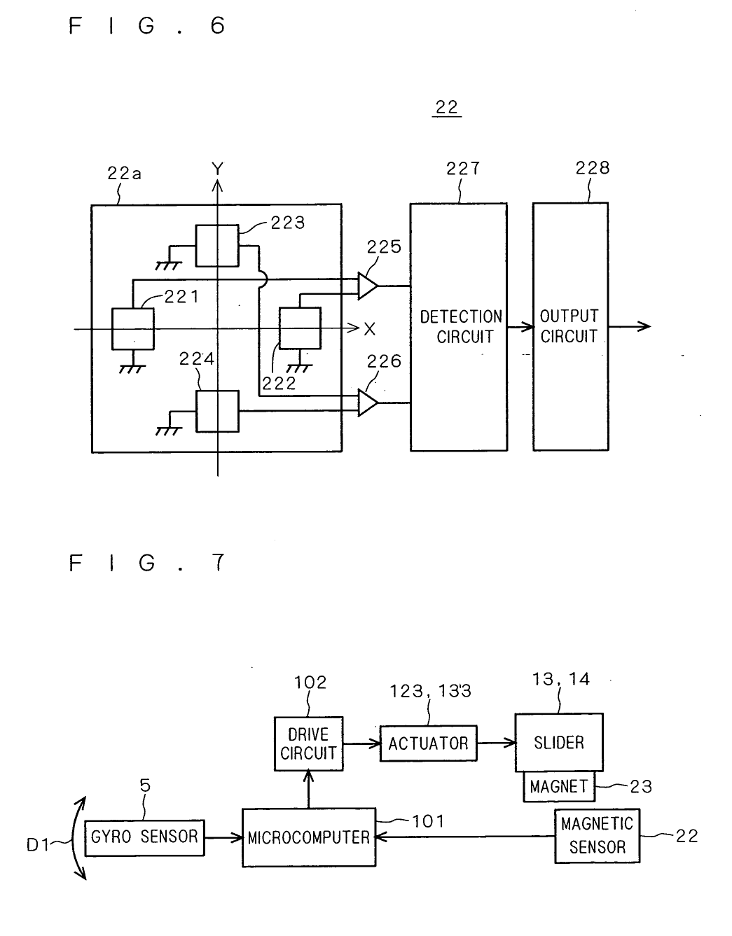

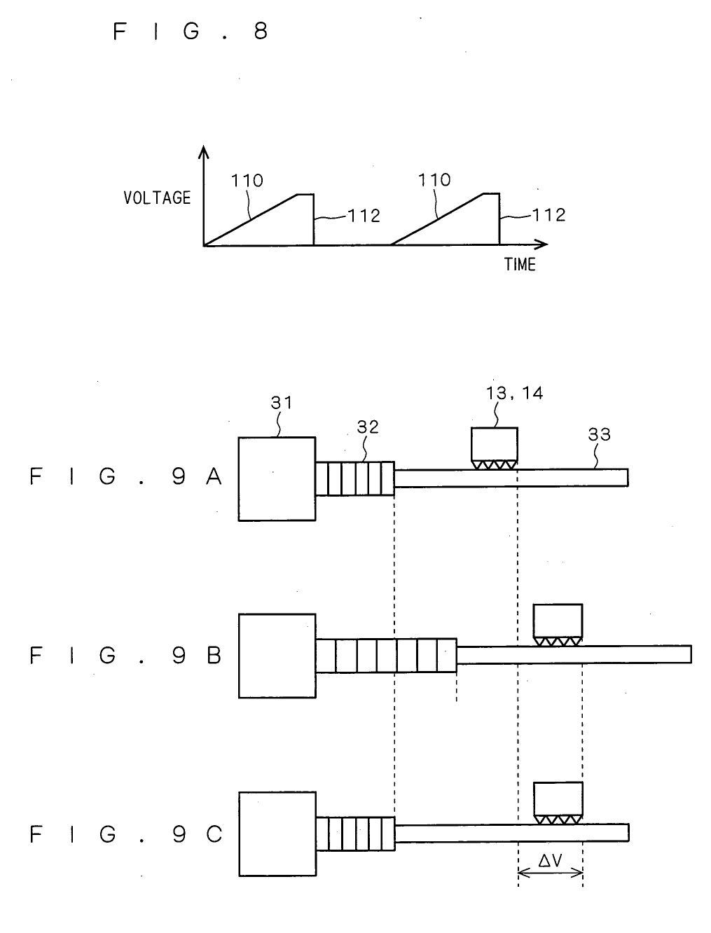

FIG. 8 shows a waveform created by the drive pulses. Each of FIGS. 9A, 9B and 9C illustrates an operating condition of the actuators 123 and 133. The actuators are initially placed in a state illustrated in FIG. 9A. Then, the drive pulses having a sawtooth waveform including a slow rise 110 and a sharp fall 112 as illustrated in FIG. 8 are applied to the piezoelectric element 32 of each of the actuators which are placed in the state illustrated in FIG. 9A. As a result, the piezoelectric element 32 gets longer slowly along a thickness thereof at the slow rise 110 of the drive pulses, so that the rod 33 secured to the piezoelectric element 32 is slowly shifted along an axis thereof as shown in FIG. 9B. During the slow shift of the drive rod 33, each of the sliders 13 and 14 frictionally engaged with the drive rod 33 moves in unison with the drive rod 33 while being kept engaged with the drive rod 33 by a friction force between the drive rod 33 and each of the sliders 13 and 14.

On the other hand, at the sharp fall 112 of the drive pulses, the piezoelectric element 32 gets shorter rapidly along the thickness thereof, which is followed by rapid shift of the drive rod 33 secured to the piezoelectric element 32 along the axis thereof. During the rapid shift of the drive rod 33, each of the sliders 13 and 14 frictionally engaged with the drive rod 33 remains in the substantially same position by virtue of an inertial force which overcomes the force of friction engagement between the drive rod 33 and each of the sliders 13 and 14, as shown in FIG. 9C. Consequently, each of the sliders 13 and 14 moves rightwards along a length of the drive rod 33 from its initial position shown in FIG. 9A to a position which is at a distance of Δ v from the initial position. Continuous application of the drive pulses having the sawtooth waveform described above to the piezoelectric element 32 results in continuous movement of each of the sliders 13 and 14 along the axis of the drive rod 33.

It is noted that leftward movement of the sliders 13 and 14 can be accomplished by applying drive pulses having a different sawtooth waveform which includes a sharp rise and a slow fall to the piezoelectric element 32. To apply such drive pulses to the piezoelectric element 32 would bring about a reverse operation to the above-described operation, to thereby achieve leftward movement. Additionally, for the waveform of the drive pulses, a rectangular waveform or other waveforms can be alternatively employed.

As is made clear from the foregoing, each of the first and second actuators 123 and 133 functions as an impact actuator, by which the slider 13 or 14 frictionally engaged with the drive rod 33 is caused to slide on the drive rod 33 as the piezoelectric element 32 gets longer or smaller. Application of the drive pulses to the first actuator 123 results in movement of the first slider 14 along the X axis, which is followed by the movement of the second slider 13 joined to the first slider 14 along the X axis. On the other hand, when the drive pulses are applied to the second actuator 133, the second slider 13 alone moves (free-running) along the Y axis, independently of the first slider 14. During the movement of the second slider 13 along the Y axis, the second slider 13 neither meets with a considerable resistance nor moves along the optical axis by virtue of the provision of the spring 18 stretched between the first slider 14 and the base plate 12 and the hard spheres 19 among the first and second sliders 14 and 13 and the base plate 12. Further, during the movement of the second slider 13 along the Y axis, a bent portion of the flexible substrate 43 connecting the first substrate 41 and the second substrate 42 is deformed to serve to absorb the movement of the second slider 13.

As described above, the camera-shake compensation apparatus 10 according to the preferred embodiment of the present invention incorporates a position detection function supposed to be performed by a position detection apparatus. The position detection function is achieved by the position detection mechanism 20 which includes the magnetic sensor unit 22 and the magnet 23 and detects a position of the second slider 13 movable relative to the base plate 12 in the X-Y plane. The magnet 23 includes a permanent magnet, and thus requires no electric wiring. Accordingly, the position detection mechanism 20 according to the preferred embodiment of the present invention can be implemented without the need to install wiring for position detection in at least one of a moving part and a fixed part. For this reason, the camera-shake compensation apparatus 10 according to the preferred embodiment of the present invention provides for improvement of efficiency in assembling, as well as minimization of the overall size of the apparatus because of a reduced wiring space. Further, a magnet is less expensive than a semiconductor component such as an infrared LED or PSD. Thus, to employ a magnet reduces costs associated with components.

The camera-shake compensation apparatus 10 according to the preferred embodiment of the present invention includes a structure in which the magnetic sensor arrays each formed of two Hall effect devices extend along the X axis and the Y axis, respectively, and the magnet 23 is situated so as to face the magnetic sensor arrays, for forming the position detection mechanism 20 which detects a position of the second slider 13 movable relative to the base plate 12 in the X-Y plane. Because of the foregoing structure, it is possible to satisfactorily detect change in magnetic field along the X axis and the Y axis, which change is caused by movement of the magnet 23, to thereby detect the position of the second slider 13 in the X-Y plane.

Also, the magnet 23 is provided in the second slider 13 which is a moving part, and the magnetic sensor unit 22 is provided in the base plate 12 which is a fixed part. Accordingly, the density of electric wiring in the second slider 13 which is a moving part is reduced, so that the second slider 13 can steadily move.

Further, in the position detection mechanism 20, two magnetic sensor arrays each formed of two Hall effect devices extend in two directions perpendicular to each other, to form a cross-shaped array, and the magnet 23 is situated so as to face a approximate center of the cross-shaped array. Thus, it is possible to detect positions on the X axis and the Y axis with the use of only one magnet. Further, the two magnetic sensor arrays are arranged such that a length of one of the two magnetic sensor arrays is substantially along a first direction (along the X axis) in which the first actuator 123 moves and a length of the other of the two magnetic sensor arrays is substantially along a second direction (along the Y axis) in which the second actuator 133 moves. Accordingly, a coordinate system used for position detection and a coordinate system used for drive control correspond to each other, which eliminates the need of performing coordinate transform for obtaining a current position of the second slider 13.

Moreover, the camera-shake compensation apparatus 10 according to the preferred embodiment of the present invention includes a circuit configuration in which a differential signal is obtained based on respective output signals supplied from the two Hall effect devices which are arranged along each of the X axis and the Y axis. Such circuit configuration allows accurate detection of a position of the second slider 13 even with change in ambient temperature.

Additionally, the present invention is not limited to the above described preferred embodiment, and other various modifications are included within the scope of the present invention.

For example, in the foregoing preferred embodiment, a structure in which the magnetic sensor unit 22 is provided in the base plate 12 which is a fixed part and the magnet 23 is provided in the second slider 13 which is a moving part has been described, by way of example. This exemplary structure produces a secondary effect of eliminating the need of wiring for position detection in the second slider 13 which is a moving part. However, if such secondary effect is not desired, the magnet 23 can be provided in the base plate 12 and the magnetic sensor unit 22 can be provided in the second slider 13. In other words, a magnet may be provided in either a fixed part or a moving part, in whichever a magnetic sensor unit is not provided, and a magnetic sensor unit may be provided either a fixed part or a moving part, in whichever a magnet is not provided.

Also, in the foregoing preferred embodiment, a structure in which the magnetic sensor unit 22 includes four Hall effect devices so that change of a magnet field along each of the X axis and the Y axis can be detected with the use of a single magnetic sensor unit has been described, by way of example. Unlike this, a single magnetic sensor unit including two Hall effect devices may be provided for detecting change of a magnetic field along each axis. For example, two magnetic sensor units may be provided. One of the two magnetic sensors is situated outwardly from the first actuator 123 and functions to detect a position on the X axis, and the other magnetic sensor is situated outwardly from the second actuator 133 (corresponding to the position of the position detection mechanism 20 described above in the preferred embodiment) and functions to detect a position on the Y axis.

Further, the two magnetic sensor arrays extending in different directions, each formed of two Hall effect devices, are not necessarily required to intersect each other at right angles. More specifically, since a given magnetic sensor array and another magnetic sensor array can detect a state of a magnetic field in a plane unless the two magnetic sensor arrays extend in parallel to each other, the two magnetic sensor arrays may intersect each other at an angle other than right angles.

Moreover, in the foregoing preferred embodiment, a case in which an impact actuator employing the piezoelectric element 32 is used as a drive part for moving the first and second sliders 14 and 13 each of which is a moving part has been described, by way of example. However, the present invention is not limited to this example, and other drive system or method may be applied.

Furthermore, in the foregoing preferred embodiment, a case in which the camera-shake compensation apparatus 10 incorporates a function performed by a position detection apparatus has been described, by way of example. However, in the present invention, the above-described structure for forming the position detection apparatus can be extracted from the camera-shake compensation apparatus, to be utilized for forming a position detection apparatus distinct from the camera-shake compensation apparatus.

While the invention has been shown and described in detail, the foregoing description is in all aspects illustrative and not restrictive. It is therefore understood that numerous modifications and variations can be devised without departing from the scope of the invention.

1. A position detection apparatus comprising:
a fixed part;
a moving part movable relative to said fixed part along two differential axes in a predetermined plane through a first guide part and a second guide part; and
a detector for detecting a position of said moving part relative to said fixed part in said predetermined plane, wherein
said detector includes a plurality of magnetic-sensor groups which are arranged at one part of said fixed part and said moving part and a magnet which is arranged at the other part so as to face said plurality of magnetic-sensor groups, each of said plurality of magnetic-sensor groups including two magnetic sensors which is arranged in different directions in said predetermined plane, respectively.

2. The position detection apparatus according to claim 1, wherein
said plurality of magnetic-sensor groups are provided in said fixed part, and said magnet is provided in said moving part.

3. The position detection apparatus according to claim 1, wherein
in said detector, said plurality of magnetic-sensor groups are two magnetic-sensor groups which intersect each other at right angles to form a cross-shaped array, and said magnet is a single magnet which is situated so as to face an approximate center of said cross-shaped array formed by said two magnetic-sensor groups.

4. The position detection apparatus according to claim 3, wherein
one of said two magnetic-sensor groups extends substantially in a first movement direction in which said moving part moves through said first guide part, and the other of said two magnetic-sensor groups extends substantially in a second movement direction in which said moving part moves through said second guide part.

5. A camera-shake compensation apparatus comprising:
a fixed part secured to a lens barrel;
a moving part which holds an imaging device and is movable relative to said fixed part along two differential axes in a predetermined plane perpendicular to an optical axis through a first guide part and a second guide part; and
a detector for detecting a position of said moving part relative to said fixed part, wherein
said detector includes a plurality of magnetic-sensor groups which are arranged at one part of said fixed part and said moving part and a magnet which is arranged at the other part so as to face said plurality of magnetic-sensor groups, each of said plurality of magnetic-sensor groups including two magnetic sensors which is arranged in different directions in said predetermined plane, respectively.

6. The camera-shake compensation apparatus according to claim 5,
said plurality of magnetic-sensor groups are provided in said fixed part, and said magnet is provided in said moving part.

7. The camera-shake compensation apparatus according to claim 5, wherein
in said detector, said plurality of magnetic-sensor groups are two magnetic-sensor groups which intersect each other at right angles to form a cross-shaped array, and said magnet is a single magnet which is situated so as to face an approximate center of said cross-shaped array formed by said two magnetic-sensor groups.

8. The camera-shake compensation apparatus according to claim 7, wherein
one of said two magnetic-sensor groups extends substantially in a first movement direction in which said moving part moves through said first guide part, and the other of said two magnetic-sensor groups extends substantially in a second movement direction in which said moving part moves through said second guide part.
